(19) United States
(12) Patent Application Publication
(10) Pub. No.: US 2016/0349140 A1
(43) Pub. Date: Dec. 1, 2016

(54) METHOND AND APPARATUS FOR WATER LEAK DETECTION

(71) Applicant: SASSAN TEYMOURI, Saratoga, CA (US)

(72) Inventor: SASSAN TEYMOURI, Saratoga, CA (US)

(21) Appl. No.: 14/720,879

(22) Filed: May 25, 2015

(51) Int. Cl. G01M 3/28

(52) U.S. Cl. CPC G01M 3/2807

(57) ABSTRACT

A device and a method for monitoring and controlling wirelessly the flow of a fluid through a piping system, said piping system having a main inlet pipe and a main inlet shut off valve, said device comprising of a fluid flow monitor located on said piping system, said monitor having a means to collect a fluid-usage data based on the frequency and the volume of the fluid flow through said piping system; and a controller having a processor to develop a fluid usage pattern based on said fluid-usage data collected by said fluid flow monitor, said processor being programed to identify a leakage in the piping system; and said controller being able to shut off said shut off valve in case of a fluid leakage.

### FIELD OF THE INVENTION

The present invention relates to a method and a device for detecting a fluid leak in a facility.

### BACKGROUND OF THE INVENTION

Modern buildings and facilities employ plumbing and water distribution systems which at times may be extensive and complicated. Water flow in such systems may be managed in an automated manner such that a consistent supply of water is delivered to the building and to various sections of the building. Because of the extensive nature of the water delivery system small leaks may go undetected for a long period of time. A broken pipe can also take a long time to be detected and by the time detection is made significant water damage may have already occurred. Similarly, in any factory, refinery or laboratory, leaky delivery system may take long time to be detected

In addition, when occupants leave a house for an extended period of time a water leak in the home can cause severe damage. Also, in remote water supply locations, water pipe breakage resulting from frozen pipes or other accidents can cause water runoff and significant loss and damage to the environment.

The prior art discloses products and instruments that detect accidents in water distribution systems and report back to a user in some form. The most common methods of doing so use sensors to detect the presence of fluid or water in specific areas of interest. When the sensors detect fluid or water they report it to a monitoring center and usually sound an alarm. For example, home owners can deploy devices that can be placed next to a laundry room or a bathroom that will detect water presence and will sound an alarm or turn on a light to signal the home owner of a potential problem. Today, companies like Comcast through their home automation business, monitors presence of water in specific areas of a home.

Such solutions are not capable of detecting water loss or leakage in locations that do not have sensors. Additionally, such detectors work by sounding an alarm and require the home owner to be present to take appropriate actions. However, without someone present at the location of the alarm the water leak can continue and subsequent damage to the property can occur.

There is a need to have a device and a method to monitor fluid (i.e. water) distribution system of a residential or commercial building and detect fluid (i.e. water) leakage in the system and stop the damage of the fluid leakage in a short period of time.

### SUMMARY OF THE INVENTION

A device for monitoring and controlling wirelessly the flow of a fluid through a piping system, said piping system having a main inlet pipe and a main inlet shut off valve, said device comprising of a fluid flow monitor located on said piping system, said monitor having a means to collect a fluid-usage data based on the frequency and the volume of the fluid flow through said piping system; and a controller having a processor to develop a fluid usage pattern based on said fluid-usage data collected by said fluid flow monitor, said processor being programed to identify a leakage in the piping system; and said controller being able to shut off said shut off valve in case of a fluid leakage.

It is a primary object of the present invention to provide a means for reducing damage by a leak in the water line of a residential or commercial building. Another object of the present invention is to help monitor water usage and thus reduce waste. This invention gathers water usage data, superimposes it on a user fed data, and then monitors the water usage continuously.

The present invention provides a method and apparatus for monitoring and controlling fluid (i.e. water) flow. It comprises of two control valves, one for the flow control and a second for the water shut off. It further comprises of a software system that monitors the flow of fluid (i.e. water) and compares it to known data to detect a change in regular usage, which may indicate a fluid (water) leak.

In a case where fluid (i.e. water) is flowing for an extended period of time and no part of the homeowner's space (e.g. a landscape) is scheduled for watering, the system is able to classify it as a leak and contact the authorities or send command to the shut-off valves to stop the water flow. Based on the parameters and previous use data the system is able to recognize the difference between water being used for a shower, for example, and a continuous water leak.

When a continuous fluid (i.e. water) flow that is outside of a normal fluid (i.e. water) usage is detected, a controller sends a signal to a shut off valve causing immediate shut off of the fluid (i.e. water) flow. This is an option that user can enable and disable from a mobile device. The present invention continuously monitors fluid (i.e. water) flow and tracks the amount of time that the fluid (i.e. water) is running. A pre-set time can be set on the device so that the fluid (i.e. water) does not continue to flow for a time longer than the pre-set time.

The present invention has a controller containing a processor that learns the pattern of fluid (i.e. water) usage during a typical week and based on that detects a fluid (water) leak. The controller is capable of being programmed such that a specific usage, such as a usage on certain days, is ignored.

The present invention has an intelligent logic program that can learn the fluid (i.e. water) usage patterns, stores in the controller and/or cloud and compares continuously the water usage with the usage patterns and decides the fluid (i.e. water) usage at a time is normal or abnormal. The intelligent logic program of the present invention can detect the normal fluid (i.e. water) usage or abnormal water usage even in an unpredictable event e.g. in case of using several time of shower or bathroom in the morning when there are some guests in the building.

The present invention has very low power detection sensor that only reports when there is an activity and is capable of shutting itself down in order to save power. The present invention uses battery powered sensors that can be augmented with solar power to sustain very long battery life as an option. The sensor can be powered with standard power line if there is one accessible.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic view of the invention when connected to a home;

FIG. 2 (a-b) shows (a) a typical household water consumption which is divided for indoor and outdoor consumptions and (b) shows a schematic diagram of the controller and its connections to the elements of the present invention;

FIG. 3 shows a schematic diagram of the controller and its connection to the elements of the present invention;

FIG. 4 shows a schematic diagram of the controller which records all the events with time stamp;

FIG. 5 shows a top level block diagram of the controller;

FIG. 6 shows a flow chart in which the decision making process of the controller of the present invention is outlined; and

FIG. 7 shows a schematic diagram of the present invention.

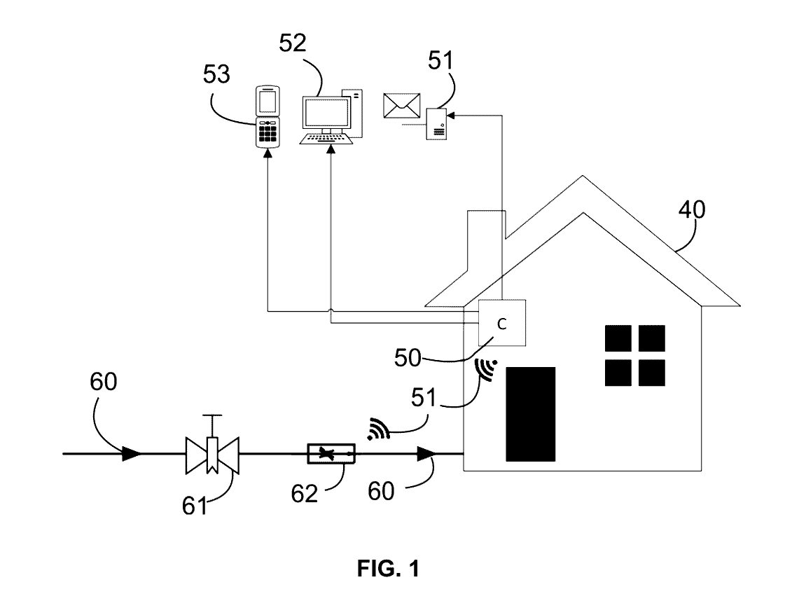

FIG. 1 shows the present invention as connected to a conventional home 40. A simplified conventional water system for a home is displayed. Water may be provided to various spaces in a home, such as the kitchen and the bathrooms. Water entering the home through a pipe 60 is regulated by an electric water shut-off valve 61, which is connected to a flow detector 62. The flow detector 62 is connected to the home's plumbing through a shut-off valve 61. Thus, water entering a house or a building 40 passes through two control valves, one for the flow control 62 and a second for the water shut-off 61. Pipes originating from the main water pipe 60 can split and provide water for such rooms as the kitchen and bathrooms. In a typical home, water is provided for kitchen sinks, toilets and bath tub or shower. Other uses for water in a building include sprinklers or taps located outside the home 40.

FIG. 1 also shows that the water flow detector 62 is wirelessly 51 connected to a controller 50 that has an energy monitoring software running on it. The controller 50 is responsible for monitoring and comparing water usage levels. The controller 50 is capable of being connected to the internet, as such, it can send emails 51 to the home owner's smart cell phones or other designated recipients, and get in contact with a monitoring center 52. Additionally, the controller is capable of contacting a homeowner and other recipients via text/SMS 53. Additionally, the controller 50 is capable of storing the usage data on cloud and retrieve it anytime required. The purpose of cloud storage is to open wide variety of application to access such a viable user data and perform analysis such as historical usage data. Such architecture, allows access to usage model from any location in the world that has internet availability.

The heart of the present invention is the design of a controller and implementation of software program which manages multiple events simultaneously and makes intelligent decision on next course of action based on historical and existing data. The Software program makes intelligent decision based on present condition and previous user data. The software is continuously learning the use model over a long period of time with capability of filtering for transient data.

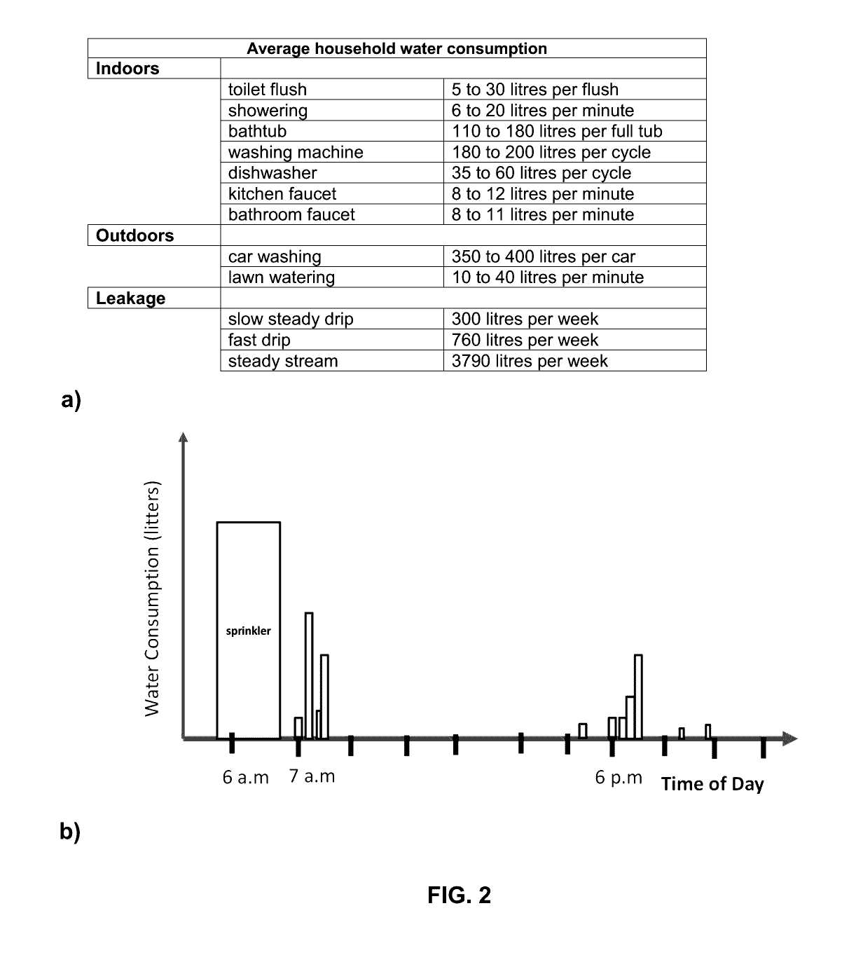

FIG. 2(a) shows a typical household water consumption which is divided for indoor and outdoor consumptions. The indoor water consumptions are related to toilet flush, showering, bathtub, washing machine, dishwasher, kitchen faucet and bathroom faucet. The outdoor water consumptions are related to car washing and lawn watering. The abnormal water usages are related to slow steady drip, fast drip or steady stream of water.

The total water usage of a household can be calculated by summation of all individual water consumption as shown in the below equation. \dot{m}ₑ is a water consumption for a specific zone of a household like a bathroom, a kitchen faucet and a dishwasher. \dot{m}ᵢ is total water consumption of a household.

$${\dot{m}}_{i} = {\sum }_{DAILY} {\dot{m}}_{e}$$

FIG. 2(b) is a diagram shown a water consumption of a household (solid line) in a different time of a day. The software program manages multiple events simultaneously and makes intelligent decision based on the variation which can happens in a daily water usage for a household. The software program is monitored the water consumption carefully and compare it with the previous data stored either locally or in the cloud. The software can learn the usage patterns in different time of a day or in different days of a week and continuously learns the water consumption based on the user preferences.

The software can send a report to a user and receive permission for a water usage which was abnormal based on the software calculation. The system learns the event and based on the information which is kept in its data base, allows the water flow in the household system.

As shown in FIG. 2(b), the system can monitor the variations in the water consumption (dotted line) and compares them with a normal water usage and makes a decision.

The system monitors and learns the water consumption and understands that in a specific time of a day, the water usage is zero. The system compares the zero water usage with the same time in different days and if the system realizes the usage that is similar to the leakage database shown in FIG. 2(a), sends a notification to the user. The user can send a shut-off command to the valve to stop the water flow or if the system has not received a proper response from the user in a specific time, it sends a shut-off command to the valve to stop the water flow.

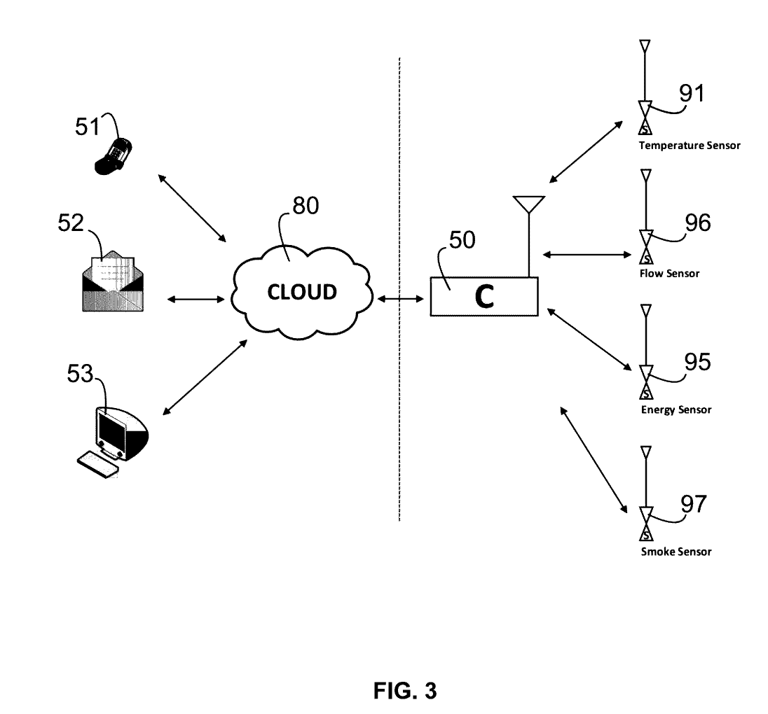

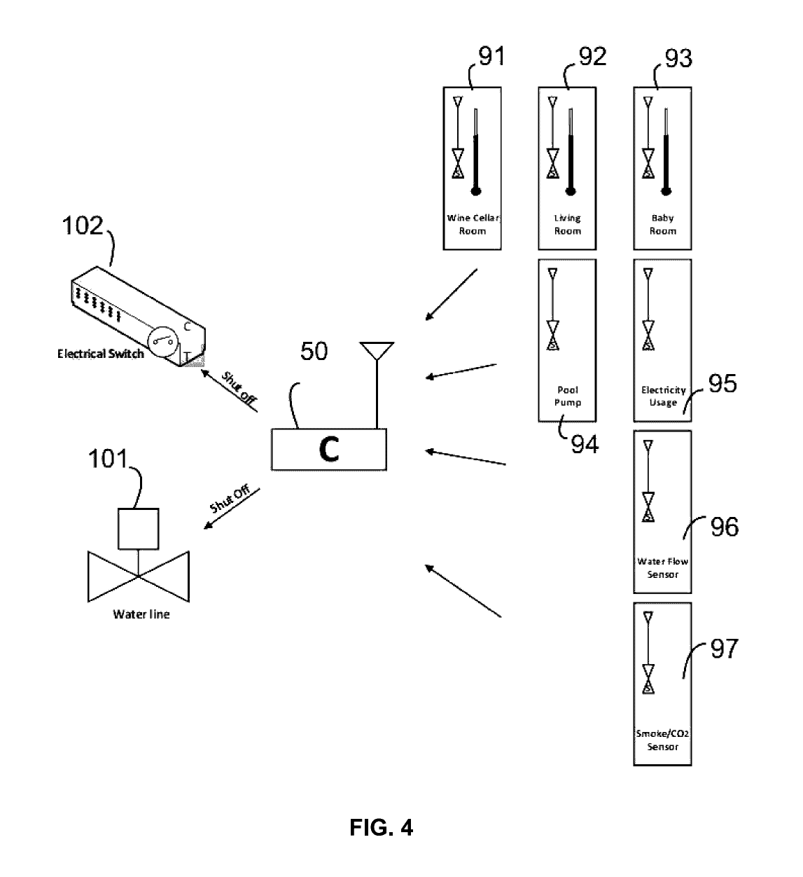

As shown in FIGS. 3 and 4, the controller 50 can also back up the existing data to cloud 80 and retrieve it if needs. By backing up the data to the cloud 80 gives the opportunity to have access to the information from any part of the world by the authorized people. The controller 50 has an ability to control and monitor another parameters of a building. All the sensors 91-97 are wireless and transmit data wirelessly to the controller 50 on dedicated data channels. This gives ability to receive data from multiple sensors 91-94 simultaneously. Sensors 91-94 are smart and have ability to power down and save battery life. As an example, vibration sensor normally power downs transmitter and only turns back ON if needs to transmit an event. They also transmit service condition data such as low battery level and malfunctioning sensors. An option for extending life of battery of sensor is connected it to solar powered battery system.

Again as shown in FIGS. 3 and 4, as part of this architecture, the controller 50 can send shut down signal to valves 101 to stop the flow of the water or turn off the heating/cooling units 102. The Controller 50 has email and text engines that can send urgent messages like SMS or notification to a mobile device 51, email 52, or notification in a specific monitoring website 53 to multiple individuals or companies that their names are listed within the controller 50 data base.

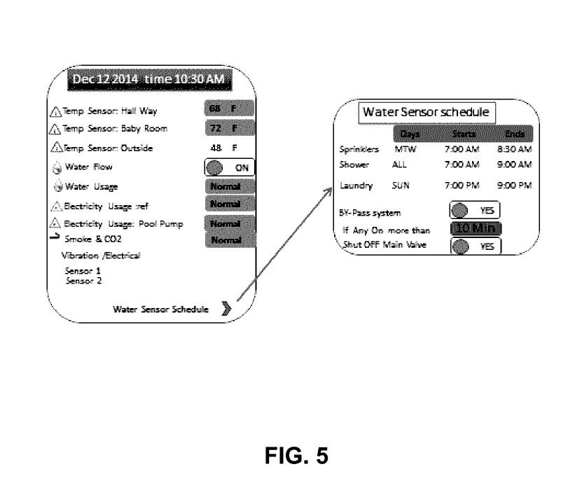

As shown in FIG. 5, the controller has real time clock that records all the events with time stamp for further analysis and review. The user can see and analyze the water usage of the unit for a specific time and compare the water usage in different time. The controller also has a software program which manages multiple events simultaneously and makes intelligent decision based on historical and existing data.

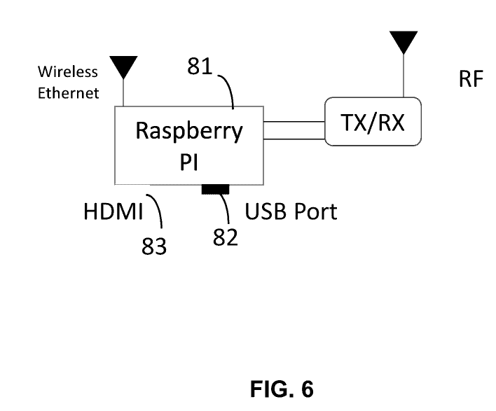

A top level block diagram of the controller is shown in FIG. 6, the controller is running a Linux server 81 inside and having several communication ports like USB port 82 and HDMI port 83 to communicate with varieties of electronic devices. It is implemented using popular Raspberry Pi controller. The unit behavior can be customized either with a smart phone or a PC. Mobile application in a smart phone will customize the controller unit for each use case. Any parameter can be changed or modified via a mobile application or a software program in a PC.

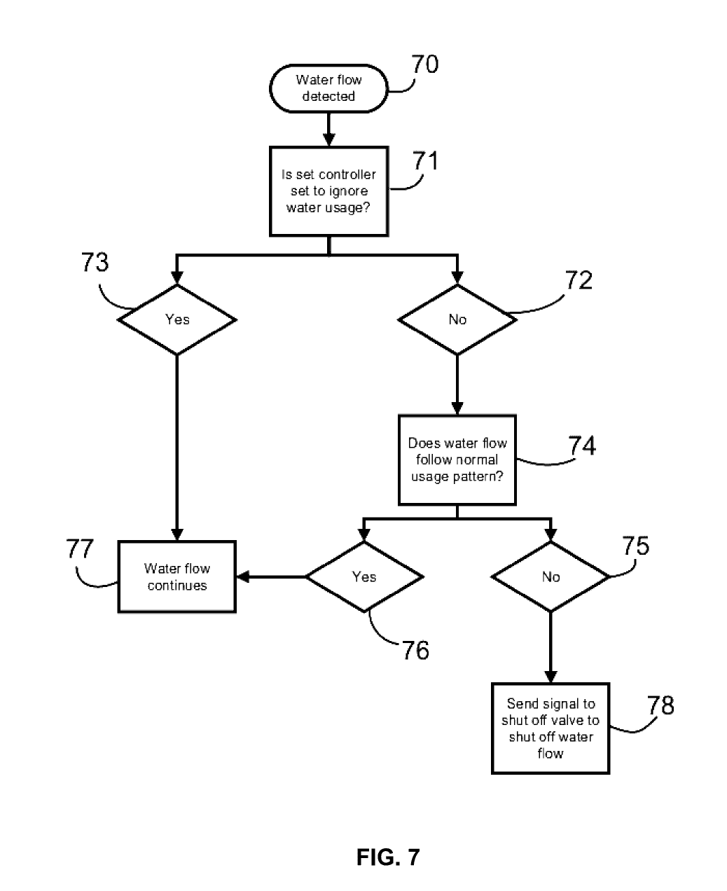

FIG. 7 shows the process by which the controller 50 determines whether to begin shutting the water flow off. When water is in use, the water flow monitor 63 sends a signal to the controller 50. The controller 50 is then made aware that water is being used 70. The controller 50 checks whether it is to ignore water usage at that specified time 71. If it is to be ignored 73, water flow is not interrupted 77. However, if the controller is set to monitor water flow 72, it checks whether the water flow fits in with predetermined usage and previous patterns 74. If the water usage conforms to previous patterns 76 then water flow is allowed to continue 77. In cases that water flow is extensive and not part of normal usage patterns 75, then the controller engages the shut off valve to shut off the water flow 78.

The controller 50 monitors the water flow and compares it to known data. In a condition in which water is running for more than predefined minutes (such as 2-5 minutes) and water is not used as determined by the user the system is able to notify the user or other authorities for potential water leakage. Since the controller 50 compares current usage to learned and predetermined data, the system is able to determine the difference between extended water use by the user or a water leak. For example, when a sprinkler system is turned on according to a predefined schedule the controller 50 allows for continuous flow. However, when a leak caused by a burst pipe or similar results in a steady water leak that is outside of the define schedule and parameters, the controller 50 detects this and signals the shut off valve which shuts off the water flow.

The water flow detector continuously 62 monitors water usage and sends a signal wirelessly to the controller whenever water is used. The controller 50 tracks the amount of time that water is running and compares it to a predetermined value. When water flow is greater than that predetermined value the controller 50 sends a signal wirelessly to the shut off valve 61 to shut down the line. The controller stops water flow until overridden by the user.

The software in the controller 50 is able to determine between normal water usage and a newly developed leak. Since typical water use follows general patterns the controller can learn to ignore normal water use. For example, toilet flushing, timed lawn sprinklers, showers and dishwasher are operated in a set way such that their water volume use and their timing follow a general pattern. As such, the controller 50 is able to learn the normal water usage of a building during the week.

The controller 50 can be present in the home or outside of the home 40. The controller 50 can be programmed by the user via graphical user interface (GUI). A user can program the controller 50 to ignore water use during certain days and times or change the conditions for periods of time when a house is unoccupied. Additionally, a user can set the controller 50 to ignore water flow during daily sprinkler time or add a specified time or duration for shower times. Extended water usage outside of these predetermined times which does not follow a normal daily use pattern will cause the controller to shut off water flow.

The controller 50 is also able to detect slow water leaks such as one that develops in toilet tank or leaky pipe inside a concrete floor. The software of the controller 50 detects a repeating or continuous pattern that such a leak would produce. In this example, water flow will be turned on for a short period of time and then turned off on a repetitive cycle. Such a pattern can be an indication that a toilet tank leak is occurring. Depending on the parameters set by the user the controller 50 can either notify the user that such a leak is occurring or, if desired by the user, shut off water flow.

The foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A device for monitoring and controlling wirelessly the flow of a fluid through a piping system, said piping system having a main inlet pipe and a main inlet shut off valve, said device comprising of:
a. a fluid flow monitor located on said piping system, said monitor having a means to collect a fluid-usage data based on the frequency and the volume of the fluid flow through said piping system;
b. a controller having a processor to develop a fluid usage pattern based on said fluid-usage data collected by said fluid flow monitor;
c. said processor having an algorithm to identify a leakage in the piping system, and wherein said processor commanding said controller to shut off said shut off valve when a leakage is detected.

2. The device for monitoring and controlling the flow of a fluid wirelessly of claim 1, wherein said algorithm identifies a leakage in the piping system through steps of:
a. determining a normal-usage pattern;
b. determining a daily usage;
c. finding a difference between the daily usage and the normal-usage; and
d. identifying said leak if said difference being larger that a predefined set-difference.

3. The device for monitoring and controlling the flow of a fluid wirelessly of claim 1, wherein said algorithm identifies a leakage in the piping system by identifying non-zero fluid flow in the pipes at times that historically there is zero fluid flow.

4. The device for monitoring and controlling the flow of a fluid wirelessly of claim 2, wherein said normal-usage comprising of the fluid-usage in a dwelling or a building.

5. The device for monitoring and controlling the flow of a fluid wirelessly of claim 2, wherein said normal-usage being automatically determined by the processor by inspecting the fluid usage over a predefined period of time.

6. The device for monitoring and controlling wirelessly the flow of a fluid of claim 4, wherein said normal-usage being automatically determined by the processor by inspecting the fluid usage over a predefined period of time.

7. The device for monitoring and controlling wirelessly the flow of a fluid of claim 4, wherein said predefined period of time being defined by a user and being any one of a week, a month, winter months, or summer months.

8. The device for monitoring and controlling wirelessly the flow of a fluid of claim 2, wherein processor determines said set-difference by determining the daily variance of the fluid-usage over said predefined period of time.

9. The device for monitoring and controlling wirelessly the flow of a fluid of claim 1, wherein said controller further having a graphical user interface.

10. The device for monitoring and controlling wirelessly the flow of a fluid of claim 1, wherein said controller having a means for internet and telephone communication.

11. The device for monitoring and controlling wirelessly the flow of a fluid of claim 1, wherein said controller being wirelessly connected to said flow monitor and said shut off valve.

12. The device for monitoring and controlling wirelessly the flow of a fluid of claim 1, wherein said controller sends text message to a user.

13. The device for monitoring and controlling wirelessly the flow of a fluid of claim 1, wherein said controller communicates with a monitoring center.

14. The device for monitoring and controlling wirelessly the flow of a fluid of claim 1, wherein said controller sends an email to a user.

15. The device for monitoring and controlling wirelessly the flow of a fluid of claim 1, wherein said device having a means to turn on only when there is an activity and is capable of shutting itself down when there is not activity, whereby the device being a low power consumption device.

16. The device for monitoring and controlling wirelessly the flow of a fluid of claim 1, wherein said device being a battery powered sensors and being augmented with a solar power to sustain very long battery life as an option.

17. A method for detecting continuous or occasional leaks comprising:
a. setting initial parameters of accepted fluid flow by a user;
b. detecting flow of a fluid using a flow monitor;
c. setting parameters for ignoring water flow by said controller;
d. learning water usage patterns;
e. controlling water flow based on said parameters and said water usage patterns; and
f. shutting down water flow wirelessly if usage is outside of said parameters and patterns.

18. The method for monitoring and controlling wirelessly the flow of a fluid of claim 17, wherein said controller sends text messages to a user when water flow is shut down.

19. The method for monitoring and controlling wirelessly the flow of a fluid of claim 17, wherein said controller communicates with a monitoring center when water flow is shut down.

20. The method for monitoring and controlling wirelessly the flow of a fluid of claim 17, wherein said controller sends an email to a user when water flow is shut down.
